(19) United States
(12) Patent Application Publication
(10) Pub. No.: US 2011/0307599 A1
(43) Pub. Date: Dec. 15, 2011

(54) PROXIMITY NETWORK

(76) Inventors: Cesare John Saretto, Seattle, WA (US); Kenneth Hinckley, Kirkland, WA (US); Jason Alexander Meistrich, Seattle, WA (US); Steven Bathiche, Kirkland, WA (US); Stuart Alan Wyatt, Camano Island, WA (US); Henry Hooper Somuah, Seattle, WA (US); Eduardo de Mello Maia, Seattle, WA (US)

(21) Appl. No.: 12/813,683

(22) Filed: Jun. 11, 2010

(51) Int. Cl. G06F 15/16

(52) U.S. Cl. 709/224

(57) ABSTRACT

A proximity network architecture is proposed that enables a device to detect other devices in its proximity and automatically interact with the other devices to share in a user experience. In one example implementation, data and code for the experience is stored in the cloud so that users can participate in the experience from multiple and different types of devices.

### BACKGROUND

Cloud computing is Internet-based computing, whereby shared resources, software and/or information are provided to computers and other devices on-demand via the Internet. It is a paradigm shift following the shift from mainframe to client-server structure. Cloud computing describes a new consumption and delivery model for IT services based on the Internet, and it typically involves the provision of dynamically scalable and often virtualized resources as a service over the Internet. It is a byproduct and consequence of the ease-of-access to remote computing sites provided by the Internet.

The term “cloud” is used as a metaphor for the Internet, based on the cloud drawings used to depict the Internet in computer network diagrams as an abstraction of the underlying infrastructure it represents. Some cloud computing providers deliver business (or other types of) applications online via a web service and a web browser.

Cloud computing can also include the storage of data in the cloud, for use by one or more users running applications installed on their local machines or web-based applications. The data can be locked down for consumption by only one user, or can be shared by many users. In either case, the data is available from almost any location where the user(s) can connect to the cloud. In this manner, data can be available based on identity or other criteria, rather than concurrent possession of the computer that the data is stored on.

Although the cloud has made it easier to share data, most users do not share the experience. For example, when two computing devices are near each other they typically do not automatically communicate with each other and share in a common experience. As more content is stored in the cloud so that a user's content can be accessed from multiple computing devices, it would be desirable for computing devices in proximity to each other to communicate and/or cooperate to provide an experience across multiple devices.

### SUMMARY

A proximity network architecture is proposed that enables a device to detect other devices in its proximity and automatically interact with the other devices to share in a user experience. In one example implementation, data and code for the experience is stored in the cloud so that users can participate in the experience from multiple and different types of devices.

In one example embodiment, a computing device automatically discovers one or more devices in its proximity, automatically determines which one or more of the discovered devices are part of one or more experiences that can be joined, and identifies (manually or automatically) at least one of the devices to connect with so that the device can participate in the experience associated with that device. Once choosing an experience to join, the device automatically determines whether additional code is needed to join the experience and obtains that additional code, if necessary. The obtained additional code is executed to participate in the experience.

One embodiment of a proximity network architecture that enables this sharing of experience includes an Area Network Server and an Experience Server in communication with the Area Network Server. The Experience Server maintains state information for a plurality of experiences, and communicates with one or more computing devices and the Area Network Server about the experiences. The Area Network Server receives location information from one or more computing devices. Based on the location information, the area network communicated with the Experience Server to determine other computing devices, friends and experiences in respective proximity and informs the one or more computing devices of other computing devices, friends (identities) and experiences in respective proximity. The one or more computing devices can join one or more of the experiences and interact with the Experience Server to read and update state data for the experience.

One embodiment includes one or more processor readable storage devices having processor readable code stored thereon. The processor readable code is used to program one or more processors. The processors are programmed to receive sensor data at a first computing device from one or more sensors at the first computing device and using that sensor data to discover a second computing device in proximity to the first computing device. Sensor information is shared between the first computing device and the second device, and positional information of the second computing device is determined based on the shared sensor information. An application is executed on the first computing device and the second computing devices using the positional information.

One embodiment includes automatically discovering one or more experiences in proximity, identifying at least one experience of the one or more experiences that can be joined, automatically determining that additional code is needed to join in the one experience, obtaining the additional code, joining the one experience, and running the obtained additional code to participate in the one experience with the identified one device. In one embodiment, the automatically discovering one or more experiences in proximity includes automatically discovering one or more devices in proximity and automatically determining that one or more discovered devices are part of one or more experiences that can be joined, wherein the identifying at least one experience of the one or more experiences that can be joined includes identifying at least one device of the one or more discovered devices and associated one experience of the one or more experiences that can be joined.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a flow chart describing one embodiment of the operation of a proximity network.

FIG. 2 is a block diagram describing one example architecture for a proximity network.

FIG. 3 is a flow chart describing one embodiment of the operation of a proximity network.

FIG. 4 is a flow chart describing one embodiment of a process for obtaining additional code.

FIG. 5 is a flow chart describing one embodiment of a process for joining and participating in an experience.

FIG. 6 is a block diagram depicting example architecture for a proximity network.

FIG. 7 depicts an example of a master computing device.

FIG. 8 is a flow chart describing one embodiment of the operation of a proximity network.

FIG. 9 is a flow chart describing one embodiment for providing sensor data to a master computing device.

FIG. 10 is a block diagram depicting one example of a computer system that can be used to implement various components described herein.

### DETAILED DESCRIPTION

A proximity network architecture is proposed that enables a device to detect other devices in its proximity and automatically interact with the other devices to share in a user experience. In one example implementation, data and code for the experience is stored in the cloud so that users can participate in the experience from multiple and different types of devices.

If a computing device does find other devices in its proximity, the computing device can automatically obtain the appropriate software application that it needs. That software application synchronizes with other devices participating in the experience. In some embodiments, an experience can be discovered in a location even if there is no other device in range currently participating in the experience. For example, a provider of a paper poster wants to create an experience for users near the poster. The poster is just paper. But the cloud knows the location of the poster and an experience is created at that location that anyone near it can discover.

The developer of a software application can program the software application to interact with a proximity network, including a multi-user environment, in unlimited ways. Additionally, many different types of applications can use the proximity network architecture to provide many different types of experiences. The proximity network architecture provides for experiences to be available on many different types of devices so that a user is not always required to use one particular type device and the application can leverage the benefits of cloud computing.

Three examples that use the proximity network architecture include distributed experiences, cooperative experiences, and master-slave experiences. Each of these three examples is explained in more detail below. Other types of applications/experiences can also be used.

A distributed experience is one in which the task being performed (e.g. game, information service, productivity application, etc.) has its work distributed across multiple computing devices. Consider a poker game where some of the cards are dealt out for everyone to see and some cards are private to the user. The poker game can be played in a manner that is distributed across multiple devices. A main TV in a living room can be used to show the dealer and all the cards that are face up. Each of the users can additionally play with their mobile cellular phone. The mobile cellular phones will depict the cards that are face down for that particular user.

A cooperative experience is one in which two computing devices cooperate to perform a task. Consider a photo editing application that is distributed across two computing devices, each with their own screen. The first device will be used to make edits to a photo. A second computing device will provide a preview of the photo being operated on. As the edits are made on the first device, the results are depicted in the second computing device's screen.

A master slave experience involves one computing device being a master and one or more computing devices being a slave to the master for purposes of the software application. For example, a slave devices can used as an input device (e.g. mouse, pointer, etc.) for a master computing device.

In another alternative, an experience spawns a unique copy whenever a person/device joins the experience. For example, consider a museum that wants to have a virtual tour. Being near the museum lets a person with a mobile computing device start the experience on their device. But their device is in its own copy of the experience, disconnected from other people who may also be experiencing the tour. Thus, the person's devices in using the proximity network, but not sharing the experience in a cooperative manner.

In many experience that involves multiple computing devices, one goal is to have user be able to access content (services, applications, data) across many different types of devices. One challenge is how devices join this multi-device experience. To solve this problem, a proximity network architecture is described herein.

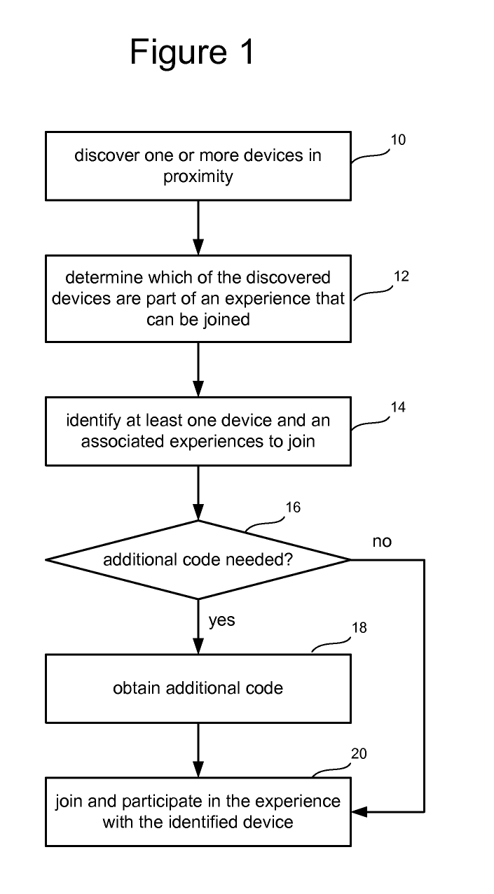

FIG. 1 is a flow chart providing a high level description of one embodiment of a proximity network. In summary, the proximity network architecture allows a device to automatically discover all the experiences in proximity to that device that it can participate in. If the device chooses to join an experience, it will get the appropriate application (or other type of software) to participate in the experience. That binary application would get synchronized into a shared context with all the devices in the experience. This enables the user to experience content from the cloud or elsewhere across many different devices in a synchronized manner with other users.

Step 10 of FIG. 1 includes a computing device discovering one or more other devices in proximity to that device. This is a process that can be performed automatically by the computing device (e.g., with no intervention by a human). In other embodiments, a human can manually manage the discovery process. In step 12, the computing device will determine which of those discovered devices are part of an experience that can be joined. Step 12 can be performed automatically (e.g., without human intervention) or manually. In some embodiments, the computing device will identify those experiences available to a user via a speaker or display. Steps 10 and 12 are one example of automatically discovering one or more experiences in proximity In step 14, one of the experiences available to be joined is identified. The identification can be automatic based on a set of rules or a user of the computing device can manually identify one of the reported experiences (or devices in proximity) to join. In some embodiments, step 12 will only identify one experience and, in that case, the system will automatically join that experience or automatically choose not to join that experience. Alternatively, the user can be given the option to join or not join the experience.

When joining a new experience, the computing device may need software to participate. As discussed above, many of the experiences require application software to participate in a distributed multi-user game, a distributed photo editing session, etc. In many cases, the software will already be loaded onto the computing device and may even be native to the computing device. In some embodiments, the software may not already be loaded on the computing device and will need to be obtained. Thus, in step 16, the computing device automatically determines whether additional code is needed. If so, the computing device will obtain that additional code in step 18. The code obtained may be object code, other type of binary executable, source code for an interpreter, or other type of code. In step 20, using/running the additional code (or the code already stored on the computing device), the computing device will join the experience chosen in step 14 and participate in that experience. As discussed above, the experience can be any of various types of applications. The technology for establishing the proximity network is not limited to any type of application or any type of experience.

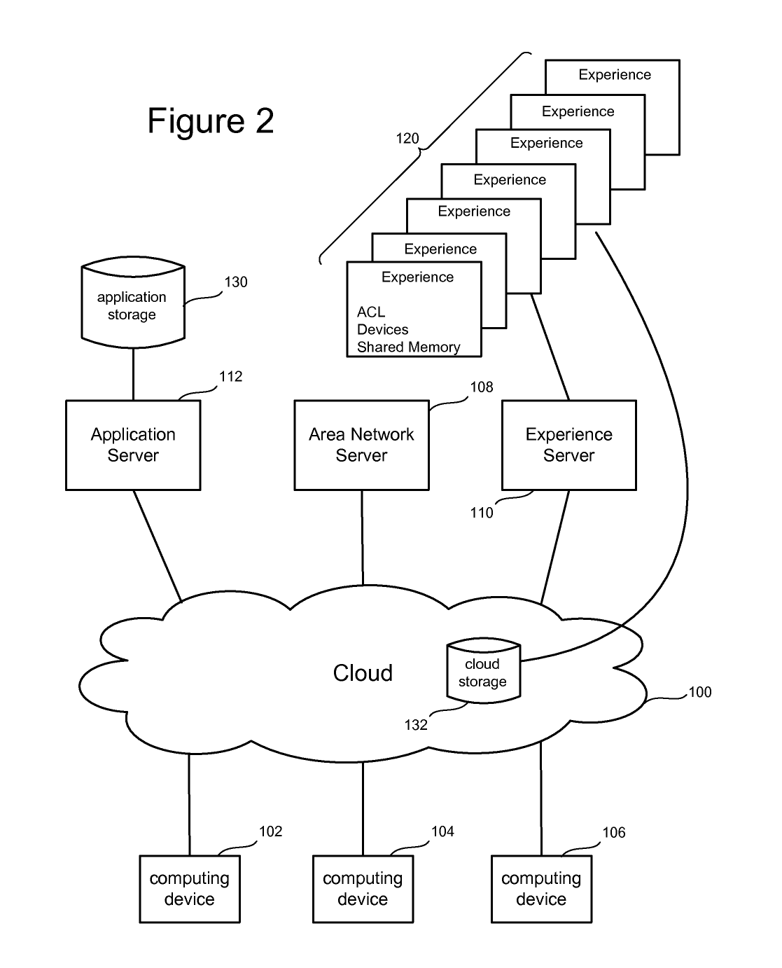

FIG. 2 is a block diagram describing one embodiment of an architecture for implementing the proximity network. Other architectures can also be used to implement a proximity network. FIG. 2 shows cloud 100, which could be the Internet, a wide area network, other type of network, or other communication means. Other devices are also depicted in FIG. 2. These devices will communicate with each other via cloud 100. In one embodiment, all communication can be performed using wired technologies. In other embodiments, the communication can be performed using wireless technologies or a combination of wired and wireless technologies. The exact form of communicating from one node to another node is not limited for purposes of the proximity network technology described herein.

FIG. 2 shows computing devices 102, 104 and 106. These can be any type of mobile or non-mobile computing devices including (but not limited to) a desktop computer, laptop computer, cellular telephone, television/set top box, video game console, automobile, tablet computer, smart appliance, etc. The computing devices that can be used in the proximity network is not limited to any particular type of computing device. Each of the computing devices 102, 104 and 106 are in communication with cloud 100 so that they can communicate with many different entities (including, in some embodiments, each other). In one example, one of the computing devices 102, 104 and 106 will come in proximity to one or more of the other computing devices. When this happens, the process of FIG. 1 can be performed. Note that although FIG. 2 shows three computing devices (102, 104 and 106), the technology described herein can be used with less than three computing devices or greater than three computing devices. No particular number of computing devices is required.

FIG. 2 also shows Area Network Server 108, Experience Server 110 and Application Server 112, all three of which are in communication with cloud 100. Area Network Server 108 can be one or more computers used to implement a service that helps computing devices (e.g. 102, 104, and 106) connect to or join an experience. The main responsibilities of Area Network Server 108 are to help determine all devices, experiences and friends near a particular computing device and provide for the selection of one of the experiences to join by the computing device.

Experience Server 110 can be one or more computing devices that implement a service for the proximity network. Experience Server 110 acts as a clearing house that stores all or most of the information about each experience that is active. Experience Server may use a database or other type of data store to store data about the experiences. For example, FIG. 2 shows records 120, with each record identifying data for a particular experience. No specific format is necessary for the data storage. Each record includes an identification for the experience (e.g. global unique ID), an access control list for the experience, devices currently participating in the experience and shared memory that store stated information about the experience. That shared memory may be represented to the application as shared, synchronized, object oriented memory that is accessed over HTTP (e.g., the shared memory is represented as a set of shared objects that can be accessed and synchronized using HTTP). The access control list may include rules indicating what types of devices may join the experience, what identifications of devices may join the experience, what user identities may join the experience, and other access criteria. The devices information stored for each experience may be a list of unique identifications for each device that is currently participating in the experience. In other embodiments, Experience Server 110 can also store information about devices that used to be joined in the experience but are no longer involved. The shared memory can store state information about the experience. The state information can include data about each of the players, data values for certain variables, scores, timing information, environmental information, and other information which is used to identify the current state of an experience. When there are no more devices/users in an experience, the shared memory for the experience may be saved to cloud storage 132 so that the experience can be resumed if a user returns to it at a later time. As described above, an experience can be a distributed game, use of a productivity tool, playing of audio/visual content, commerce, etc. The technology for implementing a proximity network is not limited to any type of experience.

Application Server 112, which can be implemented with one or more computing devices, is used as a repository for software that allows each of the different types of computing devices to participate in an experiences. As discussed above, some embodiments contemplate that a user can access an experience across many different types of devices. Therefore, different types of software modules need to be stored for the different types of devices. For example, one module may be used for a cell phone, another module used for a set top box and a third module used for laptop computer. Additionally, in some embodiments, there may be a computing device for which there is no corresponding software module. In those cases, Application Server 112 can provide a web application which is accessible using a browser for any type of computing device. Application Server 112 will have a data store, application storage 130, for storing all the various software modules/applications that can be used for the different experiences. In one embodiment, Application Server 112 tells computing devices where to get the applications for a specific experience. For example, Application Server 112 may send the requesting computing device a URL for the location where the computing device can get the application it needs.

In some embodiments, a software developer creating applications for computing devices 102, 104 and 106 will develop applications that include all of the logic necessary to interact with Area Network Server 108, Experience Server 110 and Application Storage Server 112. In other embodiments, the provider of Area Network Server 108, Experience Server 110 and Application Server 112 will provide a library in the form of a software development kit (SDK). A developer of applications for computing devices 102, 104 and 106 will be able to access the various libraries using an Application Program Interface (API) that is part of the SDK. The application being developed for computing device 102, 104 or 106 will be able to call certain functions to make use of the proximity network. For example, the API may have the following function calls: DISCOVER, JOIN, UPDATE, PAUSE, SWITCH, and RELEASE. Other functions can also be used. The DISCOVER function would be used by an application to discover all of the devices and experiences in its proximity Upon receiving the DISCOVER command, the library on the computing device would access the Area Network Server 108 identify devices nearby and experiences associated with those devices nearby. Upon receiving a set of choices of experiences to join, the JOIN function can be used to join one of the experiences. The UPDATE command can be used to synchronize state variables between the respective computing device in Experience Server 110. The PAUSE function can be used to temporarily pause the task/experience for the particular computing device. The SWITCH function can be used to switch experiences. The RELEASE function can be used to leave an experience.

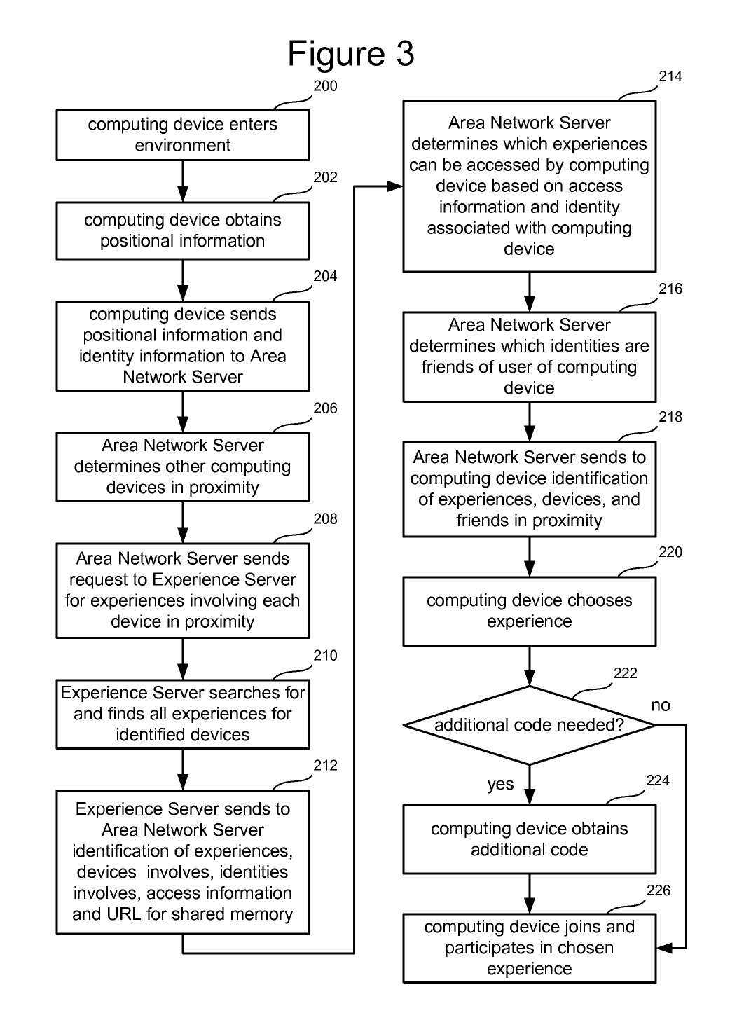

FIG. 3 is a flow chart describing one embodiment of the operation of the components of FIG. 2. In step 200, one of the computing devices 102, 104 or 106 will enter an environment. In step 202, the computing device will obtain positional information. This positional information is used to determine what other devices are in its proximity. There are many different types of proximity information which can be used with the technology described herein. In one example, the computing device will include a GPS receiver for receiving GPS location information. The computing device will use that GPS information to determine its location. In another embodiment, pseudolite technology can be used in the same manner that GPS technology is used. In another embodiment, Bluetooth technology can be used. For example, the computing device can receive a Bluetooth signal from another device and, therefore, identify a device in its proximity to provide relative location information. In another embodiment, the computing device can search for all WiFi networks in the area and record the signal strength of each of those WiFi networks. The ordered list of signal strengths provides a WiFi signature which can comprise the positional information. That information can be used to determine the position of the computing device relative to the router/access points for the WiFi networks. In another embodiment, the computing device can take a photo of its surroundings. That photo can be matched to a known set of photos of the environment in order to detect location within the environment. Additional information about acquiring positional information for determining what devices are within proximity can be found in United States Patent Application 2006/0046709, Ser. No. 10/880,051, filed on Jun. 29, 2004, published Mar. 2, 2006, Krumm et al., “Proximity Detection Using Wireless Signal Strengths,” and United States Patent Application 2007/0202887, serial number 11,427,957, filed Jun. 30, 2006, published Aug. 30, 2007, “Determining Physical Location Based Upon Received Signals,” both of which are incorporated herein by reference in their entirety. Any of the above positional information (as well as other types of positional information) can be obtained by the computing device in step 202.

In step 204, computing device 102 will send its positional information and identity information for computing device 102 to Area Network Server 108. For the remainder of this example, we will assume that it is computing device 102 that entered the environment in step 200 and is performing the steps described herein for FIG. 3. The identity information provided in step 204 includes a unique identification of computing device 102 and identity information (e.g., user name, password, real name, address, etc.) for the user of computing device 102. For example, the user may have logged in with a work profile or a personal profile. A user of a gaming console may have a gaming profile. Other profiles include social networking, instant messaging, chat, e-mail, etc. The computing device will send the identity information or a subset of that information from the profiles with the positional information to Area Network Server 108 as part of step 204.

In step 206, Area Network Server identifies other computing devices that are in proximity to computing device 102. In one embodiment, as part of step 204, computing device willing to send to Area Network Server 108 its location in three dimensional space. In that embodiment, Area Network Server 108 will look for other computing devices within a certain radius of that three dimensional location. In other embodiments, the computing device 102 will send relative positional information (e.g. Bluetooth information, WiFi signal strength, etc.). Area Network Server 108 will receive that information and determine which devices are within proximity to computing device 102. In step 208, Area Network Server will send a request to Experience Server 110 for experiences that are within the proximity to computing device 102. The request from Area Network Server 108 to Experience Server 110 will include identification of all devices in proximity to computing device 102. Therefore, the request will ask for all experiences for which any of the devices identified by Area Network Server 108 are participating in. In step 210, Experience Server 110 will search through the various records of 120 in order to find all experiences for which the identified devices are participating in. In step 212, Experience Server 110 will send to Area Network Server 108 identification of all the experiences found in step 210. Additionally, Experience Server 110 will identify all the identities involved in the experiences, the access list information for the experiences, devices participating in the experiences and one or more URLs for the shared memory.

In step 214, Area Network Server 108 will determine which of the experiences reported to it from Experience Server 110 can be accessed by computing device 102. For example, Area Network Server 108 will compare the access criteria for each experience to the identity information and other information for computing device 102 to determine which of the experiences have their access control list satisfied. Area Network Server 108 will identify those experiences that computing device 102 is allowed to join. In some embodiments, Experience Server 110 will determined which experiences computing device 102 is allowed to join.

In step 216, Area Network Server 108 will determine which of the identifies reported by Experience Server 110 are friends of the user who is operating computing device 102. In step 218, Area Network Server 108 will send to computing device 102 one or more identifications of all the experiences in its proximity, the devices participating in that experience that are also in the proximity of computer device 102, and all friends in the proximity of computing device 102. In step 220, computing device 102 will choose one of the experiences reported to it from Area Network Server 108. In one embodiment, all of the experiences received in step 218 will be reported by computing device 102 to the user via a display or speaker. The user can then manually choose which experience to join. In another embodiment, computing device 102 will include a set of criteria or rules for automatically choosing the experience. That criteria can be based on the user profile or other data. In either case, one of the experiences is chosen in step 220. In step 222, computing device 102 will determine whether any additional code is needed. In many cases, the experience involves running an application on the computing device 102 that will communicate, cooperate or otherwise work standalone or with other applications on the computing device. If that application code is already stored on computing device 102, then no new code needs to be obtained. However, if the code for the application is not already stored on computing device 102, then computing device 102 will need to obtain the additional code in step 224. In step 226, after obtaining the additional code, if necessary, the computing device 102 will join the chosen experience and participate in that experience. For example, the computing device can run the code it obtained to participate in a distributed multi-user game, in a multi-device productivity task, etc.

One embodiment can also use tiered location detection. GPS, cellular triangulation, or WiFi lookup is used to fix a device's rough location. That lets the system know where a computing device is down to a few meters. There can be experiences nearby that require the computing device to be close to a specific physical object. For example, Bluetooth technology can be embedded into an advanced digital poster. The Area Network Server lets the poster and the computing device know about each other. One scans for the other using Bluetooth (or other technology). Once they “see” each other using Bluetooth (or other technology), the experience becomes available to join. Another example is a virtual tour experience that may use Bluetooth receivers hidden in points of interest along the tour. As a computing device approaches points on the tour, the programming for the correct point plays automatically.

The notion of identifying friends is useful to many experiences. For example, a first person is in an experience and wants to invite a nearby friend to join (e.g., start a game on a mobile phone and want to invite a friend across the table to play). Another example is when a person creates an experience that only that person's friends can join (e.g., a kid on a playground starts a multiplayer game on her phone that any nearby friend can discover and join. Her friends come and go. Newcomers, who are friends, can join without her having to invite them one-by-one.)

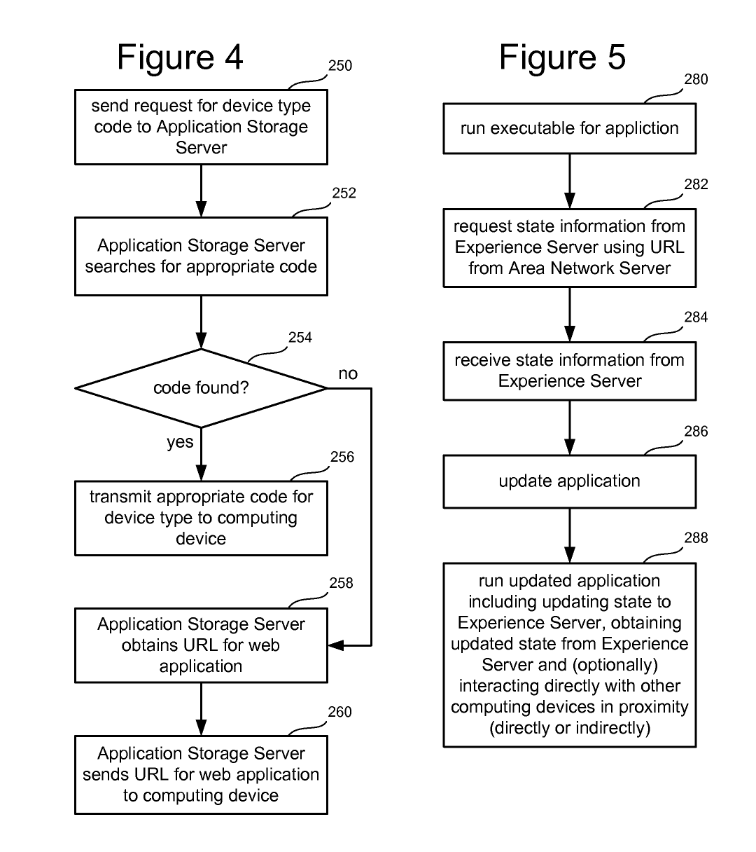

FIG. 4 is a flow chart describing one embodiment of a process for obtaining additional code. That is, the process of FIG. 4 is one example implementation of step 224 of FIG. 3. In step 250 of FIG. 4, computing device 102 sends a request for code to Application Server 112. That request will indicate the device type of computing device 102 and the experience computing device wants to join. In step 252, Application Server 112 will search its data store 130 for the appropriate code for that particular device type. If the code for that particular device type and experience is found (step 254), then Application Storage Server 112 will transmit that code to computing device 102 in step 256. In response, computing device 102 will install the code received. If, in step 254, the appropriate code for the device type and application is not found, then Application Storage Server 112 will obtain the URL for a web application (served from Application Storage Server 112 or elsewhere) that performs the same function. In this manner, a browser or other means can be used to access a web service so that the user can still participate in the experience by having a web service perform the necessary task. In step 260, Application Storage Server 112 will send the URL for the web application to computing device 102. In one alternative, the function of the Application Storage Server 112 can be performed by Area Network Server 108 or Experience Server 110. In yet another embodiment, computing device may ask a user to manually obtain the code via CD-ROM, internet download, etc.

FIG. 5 is a flow chart describing one embodiment of a process for joining and participating in an experience. That is, the process of FIG. 5 is one example implementation of step 226 of FIG. 3. In step 280, computing device 102 will run an executable for the application. The application will enable computing device 102 to participate in the experience. In step 282, the application running on computing device 102 will request state information from Experience Server 110 using the URL received from Area Network Server 108. In step 284, the application running on computing device 102 will receive the state information from Experience Server 110. In step 286, application running on computing device 102 will update its state based on the received state information. In step 288, the updated application will run on the computing device 102. Step 288 includes interacting with the user of computing device 102 as well as (optionally) other computing devices. As state of the experience/application changes, the application running on computing device 102 will update that state information to the Experience Server 110 as well as receive additional updates from Experience Server 110 by accessing the shared memory using HTTP. While running, the application can interact with other applications on computing devices that are in proximity to computing device 102 (optional).

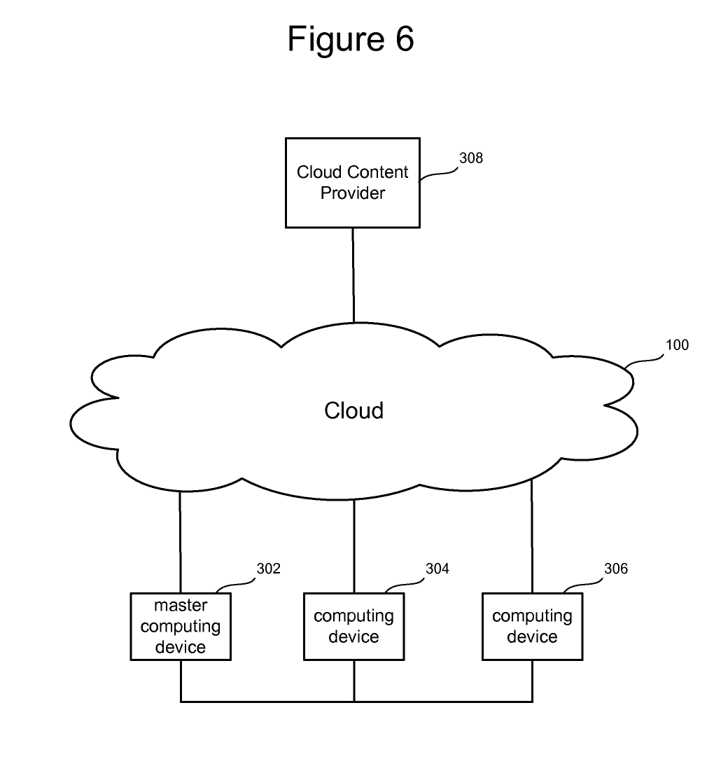

The architecture of FIG. 2 is a central model where a set of servers (e.g., Area Network Server 108, Experience Server 110 and Application Storage Server 112) manage one or more experiences. FIG. 6 is a block diagram depicting another architecture for another embodiment of a proximity network based on a peer-to-peer model. In this architecture, one local device will discover nearby devices and administer the proximity network. The administering device will have a sensor API to share sensor data between it and other devices in proximity. The administrating device can direct other devices to output lights, noise or other signals to help detect location and/or orientation. The administrator could also instruct other devices where and how to position themselves. In this manner, the experience can be scaled or otherwise altered based on how close the devices are to each other and their orientation. To accomplish this, the administrative device would need to find out properties of other devices. The communication between the devices in proximity with each other can be direct or via the cloud. In one set of embodiments, all the content and data can reside locally. In another embodiment, all or some of the content can be accessible via the cloud. In some implementations of this embodiment, the host device is acting as the Experience Server.

FIG. 6 shows cloud 100 and a set of computing devices 302, 304 and 306 that can communicate via cloud 100. Although FIG. 6 shows three computing devices, more or less than three computing devices can be used. One of the computing devices 302 is designated as the master computing device. FIG. 6 shows master computing device, computing device 304 and computing device 306 communicating with each other via the cloud or directly via wired or wireless communication means. As discussed above, some or all the content to be used as part of the shared experience between master computing device 302, computing device 304 and computing device 306 can be accessible via the cloud by storing the content at Cloud Content Provider 308. In one embodiment, Cloud Content Provider 308 includes one or more servers that provide a web application service or storage service. For example, Cloud Content Provider 308 can include applications to be loaded onto the computing devices, data to be used by those applications, media or other content. Computing devices 302, 304 and 306 can be desktop computers, laptop computers, cellular telephones, television/set top boxes, video game consoles, automobiles, smart appliances, etc. In one embodiment, the various computing devices will include one or more sensors for sensing information about the environment around them. Examples of sensors include image sensors, depth cameras, microphones, tactile sensors, radio frequency wave sensors (e.g. Bluetooth receivers, WiFi receivers, etc.), as well as other types of sensors know.

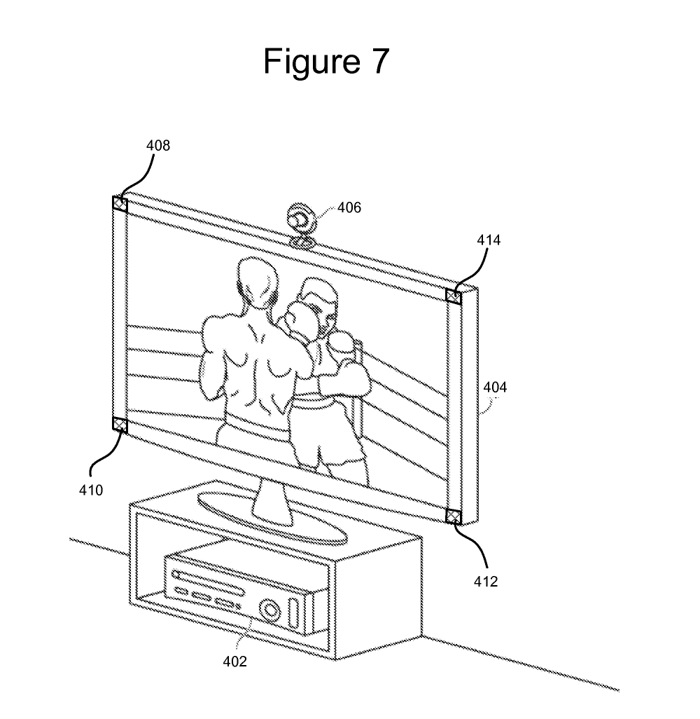

FIG. 7 provides one example of a master computing device. In this example, the master computing device include a video game console 402 connected to a television or monitor 404. Mounted on television or monitor 404, and in connection with video game console 402, are camera system 406 and Bluetooth sensors 408, 410, 412 and 414. Camera system 406 will include an image sensor and a depth camera. More information about a depth camera can be found in U.S. patent application Ser. No. 12/696,282, Visual Based Identity Tracking, Leyvand et. al., filed on Jan. 29, 2010, incorporated by reference herein in its entirety. In some embodiments, additional sensors other than those depicted in FIG. 7 could also be added to game console 402. In the embodiment depicted in FIG. 7, the various computing devices other than the master computing device will send Bluetooth signals. Bluetooth receivers 408, 410, 412 and 414 will receive the Bluetooth signals from any device in proximity. Because the four sensors are disbursed, the signal they receive will be slightly different. These different signals can be used to triangulate (based on the differences) to determine the position of the computing device emitting the Bluetooth signal. The determined position will be relative to game console 402. In other embodiments, the master computing device 302 can use WiFi signal strength to determine devices in this proximity In other embodiments, the devices can use GPS based location calculations to determine devices in proximity. In yet other embodiments, devices can output chirps (RF, audio, etc.) which can be used by the master computing device to identify computing devices in its vicinity. FIG. 7 is just one example of master computing device 302, and other embodiments can also be used with the technology described herein.

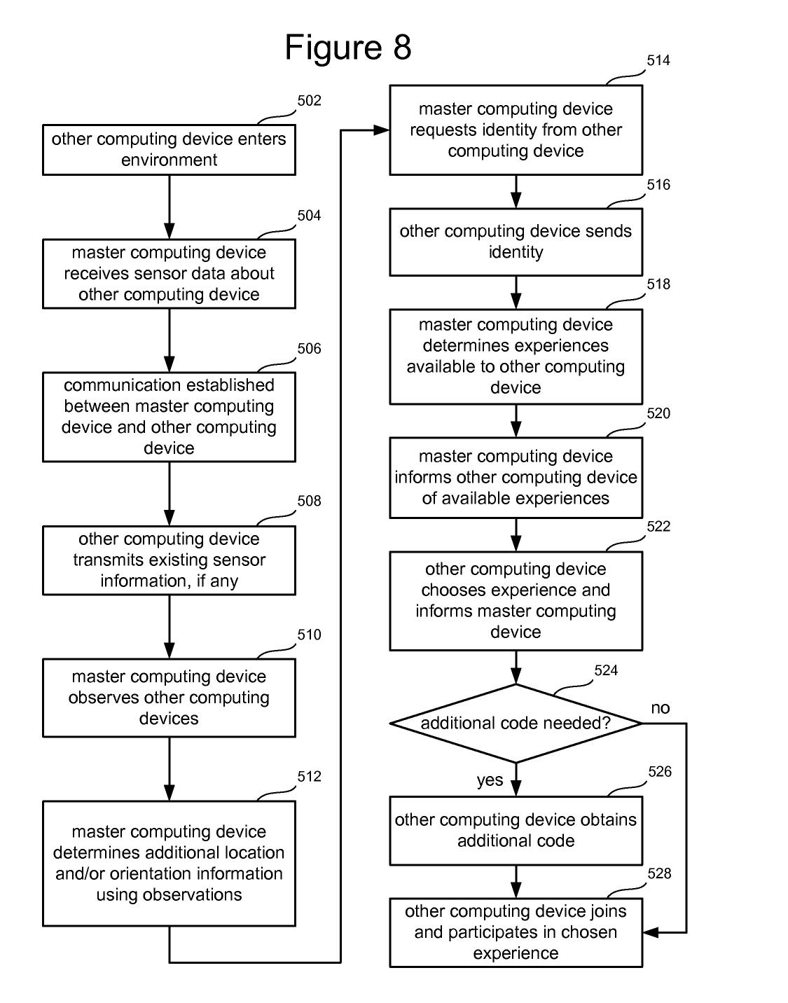

FIG. 8 is a flow chart describing one embodiment of a process of operating the components of FIG. 6 to implement the proximity network described herein. In step 502 of FIG. 8, one of the other computing devices (e.g., computing devices 304, 306, . . . ) will enter to the same environment as master computing device 302. In step 504, master computing device 302 receives sensor data about the other computing devices. For example, master computing device 302 can receive information from a Bluetooth receiver, WiFi receiver, image camera, depth camera, microphone, etc. The sensor data will alert master computing device 302 to the presence of the other computer device. In some alternatives, the computing device will receive a basic discovery message over Ethernet, WiFi, or other communication means. For example, a wireless game controller might call out to the game console that it is present. In step 506, in response to being alerted of the presence of the other computing device from the sensor data, master computing 302 will establish communication with the other computing device. Communication between the computing devices can be via cloud 100, via Cloud Content Provider 308, and/or directly through wired or wireless communication means known in the art.

In one embodiment, master computing device 302 will include a sensor API that allows other computing devices to send sensor data to master computing device 302 and receive sensor data from master computing device 302. For example, if the other computing devices include WiFi receivers, GPS receivers, video sensors, etc., information from those sensors can be provided to master computing device 302 via the sensor API. Additionally, the other computing devices can indicate their location (e.g. GPS derived location) to master computing device 302 via the sensor API. Therefore, in step 508, the other computing devices will transmit existing sensor information, if any, to master computing device 302 via the sensor API. In step 510, the master computing device 302 will observe the other computing devices and in step 512, the master computing device 302 will determine additional location and/or orientation information about the other computing devices using the observations from step 510. More information about steps 510 and 512 is discussed below.

In step 514, master computing device 302 will request identity information from the other computing devices for which it received sensor data. This allows master computing device 302 to identify friends of the users of the computing devices as well as determining access control decisions. In step 516, the other computing devices will send the identity information for the users of those computing devices to master computing device 302. In step 518, master computing device 302 will determine which experience is available to the other computing device. For example, master computing device may have only one experience currently being performed. Therefore, step 518 will simply determine whether the other computing devices in the proximity to master computing device 302 passes the access criteria for that experience. If multiple experiences are running at the same time, then master computing device 302 will determine whether the computing devices detected to be in proximity of the master computing device 302 has access rights to any of the experiences. In step 520, master computing device 302 will inform the other computing device or computing devices of any available experience for which the user of that computing device has access rights to experience.

The other computing devices will choose the experience to join (if a choice exists) and inform the master computing device 302 of the choice. For example, the choice can be provided to the user (choice among experiences or a choice to join a single experience) and the user can manually choose. Alternatively, the other computing devices can have a set of rules or criteria for making the choice automatically. In step 524, the other computing device will determine whether additional code is needed to join the experience. If additional code is needed then the other computing device will obtain the additional code in step 526. After obtaining the additional code, or if no additional code is needed, the other computing device will join and participate in the choice and experience in step 528.

The obtaining code in step 526 can be implemented by performing the process of step FIG. 4. In one embodiment, the other computing device will access an Application Storage Server as in FIG. 2. In another embodiment, the process of FIG. 4 will be used to obtain the additional code from the Cloud Content Provider. In other embodiments, the process of FIG. 4 can be performed by the other computing device obtaining the code from master computing device 302.

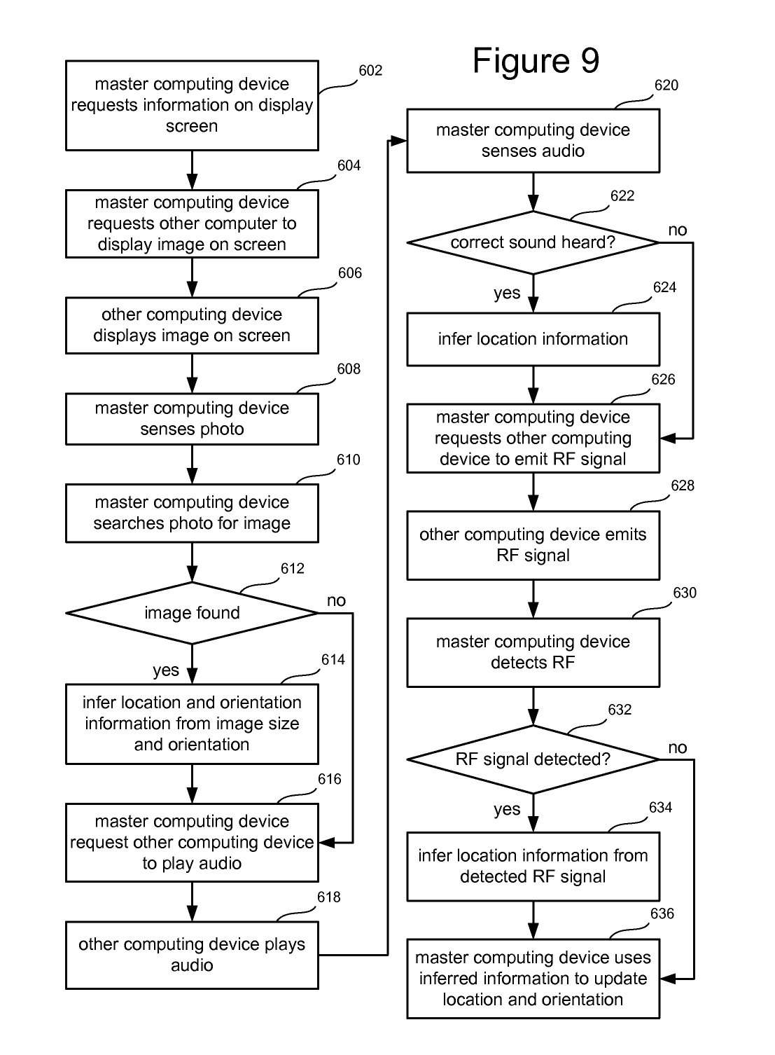

FIG. 9 is a flow chart describing one embodiment of a process of master computing device 302 observing other computing devices in order to determine additional location and/or orientation information using those observations. Thus, the process of FIG. 9 is one example implementation of steps 510 and 512 of FIG. 8. In step 602 of FIG. 9, master computing device 302 requests information about the physical properties of the display screen for the other computing device. For example, master computing device would be interested in resolution the display, brightness, and technology of the display. The other computer will supply that information as part of step 602.

In step 604, master computing device 302 will request the other computing to display an image on its screen. Master computer will provide that image to the other computer. In step 606, the other computer will display the image requested of it on its screen. In step 608, a master computer will sense a still photo using a camera (e.g. camera system 406 of FIG. 7). In step 610, master computing device 302 will search the photo for the image it requested the other computer to display. In one embodiment, master computing device 302 will request that the other computing device display a very unique image and then it will look for that unique image in the file received from camera 406. If that image is found (step 612), then master computing device 302 will infer location and orientation from the size of the image and orientation of the image found in the photo.

After inferring the location and orientation, or if no image was found in step 612, then master computing device 302 will request the other computing device to play a particular audio stream in step 616. In step 618, the other computing device will play that requested audio. In step 620, the master computing device will sense audio. In step 622, master computing device will determine whether the audio it sensed is the audio it requested the other computing device to play. If so, master computing device 302 can infer location information in step 624. There are techniques known in the art for determining distance between objects based on volume of an audio signal. In some embodiments, pitch or frequency can also be used to determine distance between the master computing device and the other computing device.

After inferring location information in step 624, or if the correct sound is not heard in step 622, master computing device 302 will request the other computing device to emit an RF signal in step 626. The RF signal can be a Bluetooth signal, WiFi signal or other type of signal. In step 628, the other computing device will emit the RF signal. In step 630, master computing device 302 will detect RF signals around it. In step 632, master computing device will determine whether it detected the RF signal it requested the other computing device to emit. If so, then master computing device 302 will infer location information from the detected RF signal. There are known techniques for determining distance based on intensity or magnitude of received RF signal. After inferring the location information in step 634, or if the RF signal was not detected, then the master computing device 302 will use all the inferred location information and orientation information to update the location or orientation information it already has.

In the example of when the shared experience is a distributed poker game, master computing device 302 may want to know the orientation of a user's cell phone before having the user's cell phone display the user's private cards. If the user's cell phone is orientated to that others can see it (including master computing device 302), then master computing device 302 will request the user (via a message on the user's cell phone) to turn and hide the display of the cell phone prior to the master computing device 302 sending the user's private cards.

In some embodiments, participation in the experience is gated on some amount of verification of proximity. For example, a computing device will not be allowed to join an experience if the master computing device cannot verify that the other computing device is in an envelope. In one example implementation, envelopes are definitions of 2-dimensional or 3-dimensional space where an experience is valid and the presence of a specific computing device within an envelope can be verified by a master device.

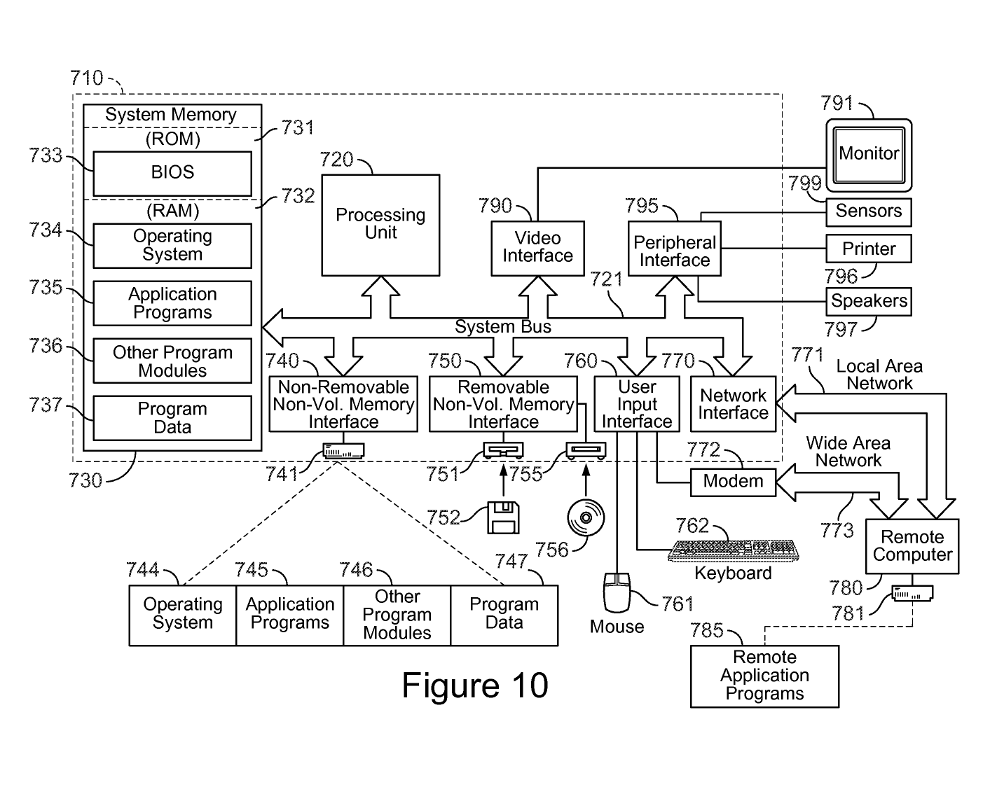

FIG. 10 depicts an exemplary computing system 710 for implementing any of the devices of FIGS. 2 and 6. Computing system 710 of FIG. 10 can be used to perform the functions described in FIGS. 1, 3-5 and 8-9. Components of computer 710 may include, but are not limited to, a processing unit 720 (one or more processors that can perform the processes described herein), a system memory 730 (that can stored code to program the one or more processors to perform the processes described herein), and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and PCI Express.

Computing system 710 typically includes a variety of computer readable media. Computer readable media can be any available media that can be accessed by computing system 710 and includes both volatile and nonvolatile media, removable and non-removable media, including RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computing system 710.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 10 illustrates operating system 734, application programs 735, other program modules 736, and program data 737.

The computer 710 may also include other removable/non-removable, volatile/nonvolatile computer storage media. By way of example only, FIG. 10 illustrates a hard disk drive 740 that reads from or writes to non-removable, nonvolatile magnetic media, a magnetic disk drive 351 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through an non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 10, provide storage of computer readable instructions, data structures, program modules and other data for the computer 710. In FIG. 10, for example, hard disk drive 741 is illustrated as storing operating system 344, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information into the computer through input devices such as a keyboard 762 and pointing device 761, commonly referred to as a mouse, trackball or touch pad. Other input devices (not shown) may include a microphone, joystick, game pad, satellite dish, scanner, Bluetooth transceiver, WiFi transceiver, GPS receiver, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral devices such as printer 796, speakers 797 and sensors 799 which may be connected through a peripheral interface 795. Sensors 799 can be any of the sensors mentioned above including Bluetooth receiver (or transceiver), microphone, still camera, video camera, depth camera, GPS receiver, WiFi transceiver, etc.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computing device 710, although only a memory storage device 781 has been illustrated in FIG. 10. The logical connections depicted in FIG. 10 include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, and not limitation, FIG. 10 illustrates remote application programs 785 as residing on memory device 781. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A method for multiple computing devices to participate in a task based on proximity, comprising:
automatically discovering one or more experiences in proximity;
identifying at least one experience of the one or more experiences that can be joined;
automatically determining that additional code is needed to join in the one experience;
obtaining the additional code;
joining the one experience; and
running the obtained additional code to participate in the one experience with the identified one device.

2. The method of claim 1, wherein:
the running of the obtained additional code to participate in the one experience includes participating in a distributed application running on multiple computing devices.

3. The method of claim 1, wherein:
the running of the obtained additional code to participate in the one experience includes a first computing device acting as an input device for a second computing device that is not physically connected to the first computing device but is in proximity to the first computing device.

4. The method of claim 1, wherein the automatically discovering one or more experiences in proximity includes:
automatically discovering one or more devices in proximity; and
automatically determining that one or more discovered devices are part of one or more experiences that can be joined, the identifying at least one experience of the one or more experiences that can be joined includes identifying at least one device of the one or more discovered devices and associated one experience of the one or more experiences that can be joined.

5. An apparatus that facilitates multiple computing devices working together based on proximity, comprising:
an Area Network Server, the Area Network Server receives positional information from one or more computing devices, based on the positional information the Area Network Server informs the one or more computing devices of other computing devices in respective proximity; and
an Experience Server in communication with the Area Network Server, the Experience Server maintains state and other information for a plurality of experiences, the Experience Server communicates with the one or more computing devices and the Area Network Server about the plurality of experiences, in response to receiving location information from a computing device the Area Network Server communicates with the Experience Server to identify one or more experiences in proximity to the computing device and informs the computing device of the one or more experiences in proximity to the computing device.

6. The apparatus according to claim 5, wherein:
the state information for a particular experience includes an identification of computing devices participating in the experience and a shared memory that indicate state of the experience.

7. The apparatus according to claim 6, wherein:
the shared memory is represented as a set of shared objects that can be accessed and synchronized using HTTP.

8. The apparatus according to claim 6, wherein:
the Area Network Server and the Experience Server are in communication with each other and one or more computing devices via a global network, the Area Network Server comprises multiple computers, the Experience Server comprises multiple computers.

9. The apparatus according to claim 5, wherein:
the location information includes relative position information based on WiFi signal strength.

10. The apparatus according to claim 5, further comprising:
an application storage server storing applications for the plurality of experiences, for each experience of the plurality of experiences the application storage server stores applications for different types of devices.

11. The apparatus according to claim 5, further comprising:
an application storage server storing applications for the plurality of experiences, for each experience of the plurality of experiences the application storage server stores applications for different types of devices and a web application that can be used by multiple types of devices.

12. The apparatus according to claim 11, wherein:
the state information for a particular experience includes an identification of computing devices participating in the experience and shared memory that indicate state of the experience;
the Experience Server interacts with the one or more computing devices to update state information in the shared objects for the plurality of experiences;
the set of shared objects can be accessed using HTTP; and
the Area Network Server and the Experience Server are in communication with each other and the one or more computing devices via a global network, the Area Network Server comprises multiple computers, the Experience Server comprises multiple computers.

13. The apparatus according to claim 5, wherein:
the Area Network Server receives identity information from the computing device for a user of the computing device, determines friends of the user that are in proximity to the computing device and transmits information about the friends to the computing device.

14. One or more processor readable storage devices having processor readable code stored thereon, the processor readable code for programming one or more processors to perform a method comprising:
receiving sensor data at a first computing device from one or more sensors at the first computing device and using that sensor data to discover a second computing device in proximity to the first computing device;
sharing sensor information between the first computing device and the second device;
determining positional information of the second computing device based on the shared sensor information; and
executing an application on the first computing device and the second computing devices using the positional information.

15. One or more processor readable storage devices according to claim 14, wherein:
the positional information includes location data; and
the executing the application includes altering performance of the application based on the location data.

16. One or more processor readable storage devices according to claim 14, wherein:
the positional information includes orientation data; and
the executing the application includes altering performance of the application based on the orientation data.

17. One or more processor readable storage devices according to claim 14, wherein:
the sharing sensor information includes the second computing device sending information from a camera or an audio sensor to the first computing device.

18. One or more processor readable storage devices according to claim 14, wherein:
the sharing sensor information includes the first computing device instructing the second computing device to perform a function that emits sound or light and the first computing device detecting the respective sound or light.

19. One or more processor readable storage devices according to claim 14, wherein:
the receiving sensor data at the first computing device includes receiving a Bluetooth signal from the second computing device.

20. One or more processor readable storage devices according to claim 14, wherein:
the receiving sensor data at a first computing device includes receiving a Bluetooth signal from the second computing device at multiple sensors on the first device and calculating a relative location of the second computing device based on differences in received signal by the multiple sensors.
